(19) United States
(12) Patent Application Publication
(10) Pub. No.: US 2018/0033048 A1
(43) Pub. Date: Feb. 1, 2018

(54) Method for Vehicle Users to Generate Advertising Revenue and Display Notices of Missing Children & Emergency Alerts

(71) Applicants: Le Le, Puyallup, WA (US); Rachael Bratsch, Puyallup, WA (US)

(72) Inventors: Le Le, Puyallup, WA (US); Rachael Bratsch, Puyallup, WA (US)

(21) Appl. No.: 15/224,141

(22) Filed: Jul. 29, 2016

(51) Int. Cl. G06Q 30/02; G09F 9/35; G09F 21/04; H04W 4/22; H04W 4/00

(52) U.S. Cl. CPC G06Q 30/0265; G06Q 30/0273; H04W 4/22; H04W 4/003; G09F 21/048; G09F 9/35

(57) ABSTRACT

A method of creating fees or other revenue for vehicle display users who own or lease display and portable transmitting/receiving equipment. A party running an advertising server transmits and receives communications from the portable transmitter/receiver. The transmitter/receiver functions both to select and display advertisements and offers but also to display emergency and missing children alerts that are received through the emergency broadcast system. Vehicle display users may also generate their own local ads and offers. Responders to the advertisements and offers participate by downloading an app from their cell phone app store that allows them to receive messages when the potential responder are in the vicinity of the vehicle user advertising display. The advertising server records activity generated by vehicle user displays and collects revenue from advertising sources and distributes revenue to the vehicle display user.

### BACKGROUND—PRIOR ART

U.S. Patents

| | Kind | | |
|---|---|---|---|
| Pat. No. | Code | Issue Date | Patentee |
| 5,132,666 | A | Sept 17, 1990 | Glen Fahs |
| 6,414,602 | B2 | Jul. 2, 2002 | Lenny Polynkov |
| 6,850,209 | B2 | Feb. 1, 2005 | Matt W. Mankin, Brad Markavy, |
| | | | Michael Plaisdakis, Adam Whiton |
| 8,811,957 | B2 | Aug. 19, 2014 | Aleksandar Jovicic, Cyril |
| | | | Measson, Thomas |
| | | | Richardson, Juryi Le, |
| | | | Vincent D. Park, Matthew |
| | | | Scott Corson |

Patent Applications

| Application | Kind | | |
|---|---|---|---|
| number | Code | Publication Date | Inventor |
| 20030048294 | A2 | Mar. 13, 2003 | John E. Arnold |
| 20040212548 | A1 | Oct. 28, 2004 | Mark Ruttenberg |
| 20140308932 | A1 | Oct. 16, 2014 | Jung Soo Lee, Jeong Woo |
| | | | Lee, Hyo Taeq Jung, Bum |
| | | | Ho Kim, Yeon Jeong Jeong, |
| | | | Sun Wong Moon, Ki Song |
| | | | Yoon |

### 1. Field of the Invention

The field of the invention is wirelessly communicating advertising messages to vehicles that has an electronic or LED display. The current invention establishes a method that allows vehicles users to choose advertisements for display from an option list at a central advertising server and then have the advertising server collect payment when someone viewing the advertisement accesses the sites listed on the advertisement with the vehicle user's promotion code. The advertising server then remits payment to the vehicle user.

### 2. Background of the Invention Field

Vehicle advertising has been on the market for years, possibly from the time vehicles were first commercialized. Stationary sign on top of the vehicle, on the side of the vehicle and in front of the vehicle have been common for decades. In the early 1990s U.S. Pat. No. 5,132,666 introduced the concept of a mobile electronic display that went on the top of the vehicle and then could be controlled by a processor to change the sign. Subsequent U.S. Pat. No. 6,414,602 added specific advertising for zones, fine tuning the advertising for the location of the vehicle. U.S. Pat. No. 8,811,957 advanced the art to where wireless communication sent advertising messages from a central server to the display on the vehicle based on the vehicle's location. Application number 20140308932 discusses using the smartphone to bring in messages from the server and then use that message to communicate what advertisement or offer should be on the vehicle's display.

The current art under patents has the advertising selected by a central server and allows for electronic delivery through phone, the Internet, or other electronic delivery. None of the current state of art methods for advertising delivery allows for selection of the ad by the vehicle user, nor do the current methods allow vehicle users to sell and enter in ads or offers from companies groups or individuals that they approach. No other method was found that allowed the vehicle users to receive income based on the responses and action of the people who view the electronic display of those users.

### 3. Description of Prior Art

U.S. Pat. No. 5,132,666 is a vehicle mounted advertising system. (From the Abstract) “The invention features a system for displaying information upon a vehicle. An electronic display is connected to a processor generates character and graphics information. A power supply is connected to the electronic display.” This patent displays messages chosen by a central source and not messages chosen by the vehicle user to match his or her current environment. The device of this patent is mounted on the top of the vehicle and is not an LED screen.

U.S. Pat. No. 6,414,602 (from the Abstract) “offers a system of advertising has a source of advertising information adapted to transmit advertising information of different contents substantially corresponding to objects to be advertised situated in different advertising zones and formed as a server unit, a plurality of moving vehicles, each of the vehicles being provided with a receiver for receiving the advertising information of different contents.” This method has the advertising displayed on the vehicle determined by a central source based upon the vehicle's location. This patent does not offer a way of monitoring people's response to the ad and rewarding the vehicle user for a response to an ad. This product is also a large non LED display on the top of a vehicle.

U.S. Pat. No. 6,850,209. (from the Abstract) “A system for publicly displaying messages includes elements carried by an automotive vehicle. In some embodiments the vehicle carries a publicly visible electronic display; a sensor for sensing the brightness of light in the vicinity of the display; and illumination varying circuitry for varying the brightness of light generated by the display in response to brightness detected by the sensor.” This is a large sign for the top of the vehicle. It doesn't allow the driver flexibility to determine what should be on the sign, nor collect revenue based on the responses, nor pay the vehicle user for a response generated by the vehicle user's display.

U.S. Pat. No. 8,811,957. (From Abstract) “Methods and apparatus related to communicating advertisements and/or service announcements to devices in a communications system are described. In various embodiments mobile devices are used as mobile advertisement transmission platforms. Advertisements may be downloaded to the wireless communications device along with transmission constraints.” This patent deals with a method where advertising messages are controlled by a central source, rather than the vehicle user, and there is not a method for the vehicle user to collect variable revenue based on the response from the advertisements running on the device on their car.

Application number 20030048294. (From Abstract) “A display advertisement system and method allow a provider of display ads to create templates that can be used to quickly create display ads in an automated manner. Information updates regarding merchants can be received, and display ads are automatically regenerated to include the updated information.” This application describes a device that creates advertisements from templates posts centrally controlled advertising, but is written to cover large vehicle top advertising as well as advertisements that run on the inside or outside of the vehicle. The method does not allow commissions to be paid to the vehicle user nor does it post any emergency broadcasts.

Application number 20040212548. (From the abstract) A method and system for displaying advertisements on an electronic display is disclosed. This includes using an electronic display that is attached to a processor that receives advertising and information via a data storage or data transfer device such as a global computer network, e.g. Internet.” This is not an LED display, and the application offers a method where people are reimbursed via screen time rather than by responses and the vehicle user does not select advertisements nor do they collect a commission for responses to the advertisement.

Application number 20140308932. (From Abstract) A method of transmitting and receiving digital signage contents, which is capable of easily transmitting and receiving digital signage contents using a smartphone's application, is disclosed. According to an aspect, the method of transmitting and receiving digital signage contents includes: executing an application; transmitting a message for requesting digital signage contents displayed on a digital signage display device to a digital signage manager through the application; receiving the digital signage contents from the digital signage manager; and outputting the received digital signage contents.” This application does not have a method for the vehicle user to collect commissions or choose ads that work best in their particular area.

Besides the point that none of the prior is set up to allow vehicle users to select their advertisement or offers, obtain offers or advertisements on their own, or collect revenue based on the response rates to the offers or advertisements, none of the previous art found includes the addition of the emergency and missing child alert systems.

### SUMMARY OF THE INVENTION

This method allows the vehicle user to generate revenue through the display of advertising on an LED or other electronic display on their vehicle by coordinating with advertising programs created by a party running an advertising server and/or by advertisement and offers obtained by the vehicle user. The method also allows emergency announcements or alerts about missing children delivered over the emergency broadcast network.

### Definitions:

Groups: people or companies that have a like function in the method;
Party: a company, partnership, other organization or individual that takes on a function in the method;
Vehicle User: An individual, partnership or company that obtains a display and portable transmitter/receiver in order to display advertising and/or offers on the display. The display showing advertising or offers might also be mounted on windows, buildings and bikes or other locations;
Responders: people who see the display with the advertisement or offer and respond to that offer with the means offered by this method.

### Groups Involved in the Method

The method has five groups that contribute to the method.
1. A manufacturer and/or marketer of the electronic display and the transmitter receiver units that vehicle users will purchase or lease or otherwise obtain to participate in the program.
2. The party that runs the advertising server, locating and posting potential advertisements, allowing vehicle users to access those advertisements and collecting advertising, click through and download fees, and distributing a percentage of those fees to users. The manufacturer and/or marketer and the party that runs the advertising server could be the same party.
3. The vehicle user who has the display, which could be purchased or leased, and who chooses advertisements to run and collects payment based on the responses to the advertisement by those who see it. Vehicle users can also generate their own ads and offers from local advertisers that he or she can enter through the advertiser server. Vehicle user will be able to post advertiser generated ads or vehicle users can create their own ads with software generated software. The electronic display may be shown other than on a vehicle, in an apartment window, or other location not vehicle related.
4. The responders to the advertisement. The responders will need to activate an app that they can find in the app store appropriate to their cell phone.
5. Missing child and emergency networks

### Method for Posting Advertisements on Advertising Server

1. The party that runs the advertising arranges for ads and offers from a wide variety of sources to be placed on the server with agreements with each source regarding payment for actions eventually taken by a responder to those advertisements and offers to that agreement.
2. Vehicle user can also post advertisements for their own services or advertising offers that they have sold or arranged from their own contacts into the advertising server, from a variety of sources including local stores and possibly radio station or locally run web sites.

### Method for Downloading Ads by the Vehicle User

1. Vehicle user goes onto to the advertising server web site from a computer type device that has a memory port. This could be a desktop computer, laptop computer, table, pad type device or cell phone.
2. The vehicle user registers with the advertising server and receives a vehicle user number. That vehicle user number allows the vehicle user to access advertisements and other offers on the advertising server.
3. The advertising server program allows vehicle users view available advertisements and to choose which advertisements he or she wants to use over the short or long term.
4. Vehicle user downloads those advertisement onto to a memory device that can be transferred to the portable transmitter/receiver through a memory port.
5. Prior to downloading ads into the vehicle user's computer device, programing in the advertising server codes each advertisement or offer with the vehicle user's number, which could be an alphanumeric symbol, or an electronic symbol.
6. When the advertising server downloads advertisements and offers to vehicle users computer device it contains programing that will show the downloaded advertisements and offers on the vehicle user's display instructions on how to select advertisements and offers.
7. The vehicle user follows the program's instructions, using the up, down and enter buttons on the portable transmitter/receiver to select the advertisements and offers they wish to show on the display and how often they want the advertisement or offer to stay on the display.
8. In another embodiment the programming in the advertising server will allow vehicle users to set up a personal channel where they can have advertisements or offers only for their vehicle
9. In another embodiment multiple memory type ports on the portable transmitter/receiver would be used to allow transfer from a variety of memory media such as USD ports, CD ports or other.
10. In another embodiment, ads can be downloaded directly from the advertising server by the portable device without the use of a memory device through the use of wireless Internet connections.
   Method by which People Respond to Advertisements or Offers for Display
1. The party operating the advertising server will need to have their app included in the app stores available on cell phones.
2. Responders who view the display and are interested in the content of the ad or message will need to download the app from the app store on their smartphones.
3. Responders who have downloaded the app will receive a message on their smartphone asking if they would like to receive the offer, with a small version of the offer showing on their smartphone when a vehicle user's display is within wireless range of their cell phone.
4. If the responder who downloaded the app selects Yes, the responder will receive an acknowledgement such as a retail store coupon, a clickable coupon for use at on online store, a confirmation code or QR code, or website address links.

### Method for Vehicle User to Collect Fees Based On Responses to the Advertisements or Offers.

1. When the responder checks Yes to coupon or other offer Yes, the message is sent to the advertising server and the advertising server sends the appropriate material to the responder of the advertisement.
2. The advertising server registers the vehicle user number and the advertising party initiates action to collect the fee for generating a response and sending the appropriate material to the responder to the advertisement.
3. The coupon, offer or other material sent to the responder will also include the vehicle user's number so that the vehicle user can receive additional fees if the coupon or offer is redeemed.
4. The advertising server will credit the vehicle user with the specific ID number that was registered when the responder's Yes message was received.
5. The advertising server will credit the vehicle user with the appropriate revenue for the response generated.

### Features of the Portable Transmitter/Receiver Device

1. WiFi Bluetooth capable
2. Cell phone antenna and reception (only for the emergency broadcast network)
3. On/off function which could be a button or switch.
4. Navigation buttons, up and down
5. Selection button
6. Memory Port
7. Rechargeable batteries
8. Power cords for recharging in a vehicle charging port or a power cord for plugging into a standard wall outlet.
9. Either a connection core or wireless connection to the display. Both embodiments are included.
10. A means of holding up the display in the vehicle which could include including flexible mounting rods, hooks, hook and loop connections, snaps, and magnets.

### Features of the Display

1. The display comes in different sizes, with the vehicle user choosing the size they feel is best for them.
2. Display of signal it receives wirelessly from the portable transmitter/receiver.
3. Separate cell phone antenna and reception.
4. Have a flashing strobe light feature to catch people's attention in the case of an emergency broadcast.
5. The display has an ambient light sensor integrated circuit to read ambient lighting levels and adjust the brightness of the display.
6. Rechargeable batteries.
7. Power cords for recharging to vehicle charging ports and a cord for plugging into standard wall outlet.
8. A memory port,
9. Connection cord to potable transmitter/receiver.
10. Display will have configurations for use inside or outside a car, plus inside an indoor window, and use with a backpack, on the outside of the backpack as a user walks.
11. In an additional embodiment the display will be waterproofed.
12. In an additional embodiment the display will have a speaker function.
13. In another embodiment the display will have wireless connection to the portable transmitter/receiver.
14. In another embodiment the emergency and missing child alerts are received by the wireless feature of the portable transmitter/receiver which will then show the alerts the display of the vehicle users.
15. In another embodiment the display has wireless cell phone reception for emergency and missing child alerts.
16. In another embodiment the display is configured to mount on the inside or outside of a non-vehicle window.
17. In another embodiment the display is configured to mount to the outside of a backpack
18. In another embodiment the display is waterproof.

### How the Method Works

A supplier of the required vehicle user equipment supplies a portable transmitter/receiver, display and possibly a speaker to individuals interested in the proposition of displaying advertisements or other response based programs in return for collecting a fee for each response generated by the offer displayed. The party running the advertising server, who may collect a percentage of the revenue generated by the vehicle user, arranges for the needed apps to be placed in cell phone app stores, negotiates commission or other fee arrangements with companies who offer deals, records responses generated by each vehicle user and pays fees and/or commissions to the vehicle user. The party running the advertising server also provides programming for advertisers and for vehicle users for use in their computer to select advertisements and offers and to upload coupons, advertisements or other local ads onto the advertising server. The vehicle user may use advertisements and other offers from the advertising server, but is also able to generate advertising or other types of offers from businesses in their own local area, or to generate ads to support their own business, in areas frequent by the vehicle user and upload those offers to the advertising server. Responders can respond to the offers on the display by downloading a specific app related to the method from an app store on their cell phone and by responding to inquiries on their cell phone when they are within wireless range of a vehicle user display.

For the missing child alerts, the missing child network will broadcast the information on the vehicle user's display with whatever information is available, such as images, video, description of the children and names and pictures of the abductor,

For emergency alerts, the system will broadcast whatever details are available from the emergency alert broadcast network.

### DRAWINGS

### DRAWINGS—FIGURES

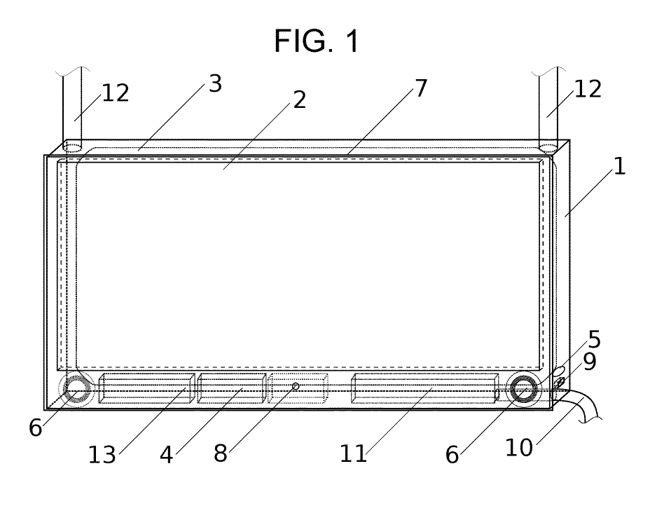

FIG. 1. Drawing of the front of the display.

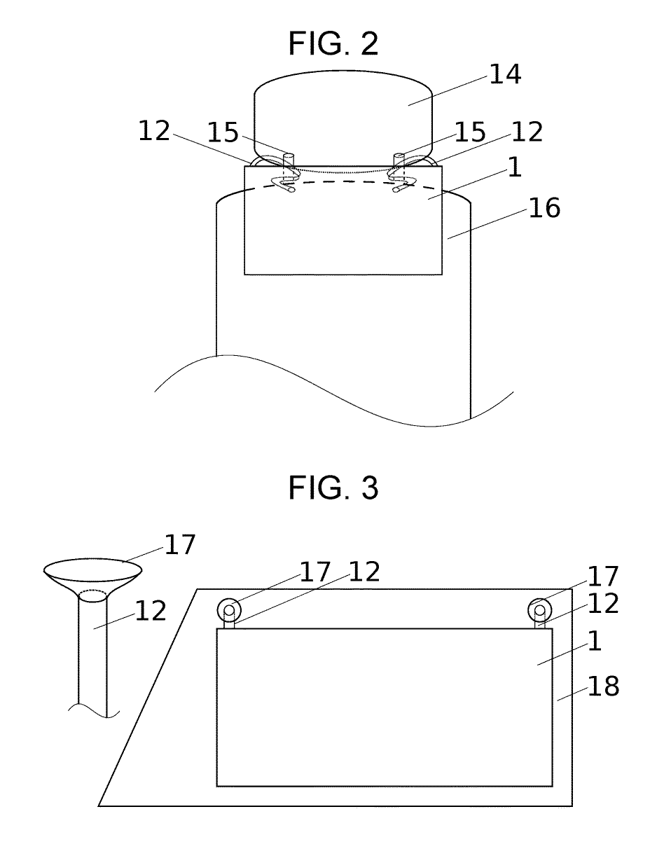

FIG. 2. Shows a method of how the display can be attached to the seat to do the programming actions for choosing advertisements and offers, and for users to enter in their own advertisements and offers

FIG. 3. Drawing showing how the display attaches to the inside of a vehicle.

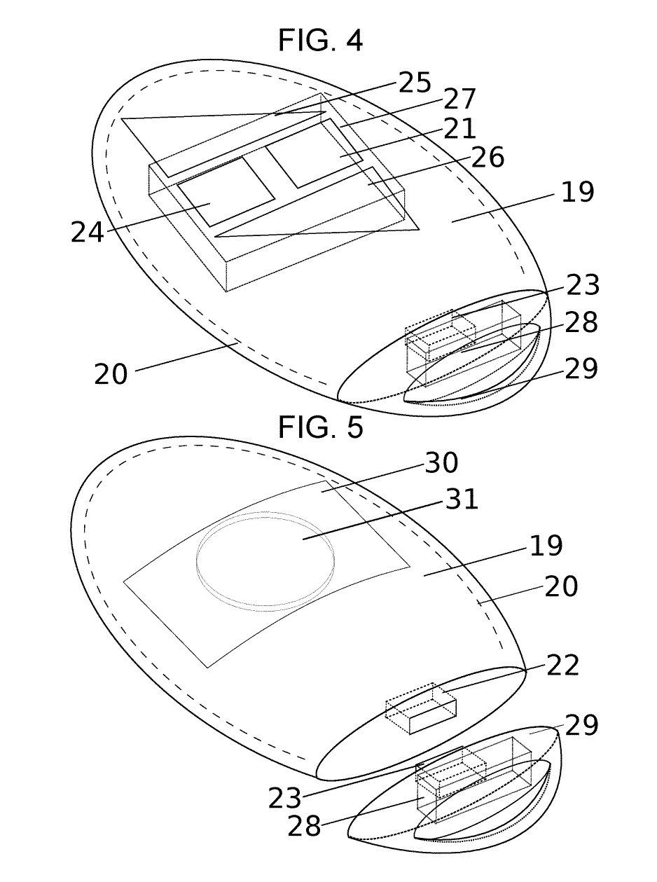

FIG. 4. Drawing showing the front side of the portable transmitter/receiver with the USB holder out.

FIG. 5. Drawing showing the back side of the portable transmitter/receiver USB holder pulled away from the USB port on the portable transmitter/receiver.

### DRAWINGS—REFERENCE NUMBER

1. Display unit.

2. LCD display screen.

3. Display unit cell phone antenna.

4. Display unit cell phone module.

5. Display unit on/off switch.

6. Speakers.

7. LCD strobe lights.

8. Ambient light sensor and control module.

9. Memory device port.

10. Power cord.

11. Battery

12. Flexible mounting rods

13. Display processor module

14. Car Seat Headrest

15. Headrest posts

16. Car Seat

17. Suction cups for portable mounting rods.

18. Car window

19. Portable transmitter/receiver device

20. Portable transmission/receiver device cell phone antenna

21. Portable transmitter/receiver on/off switch

22. USB port

23. USB drive

24. Select button

25. Next button

26. Back button

27. Transmission/receiver module with Bluetooth antenna

28. USB drive memory module

29. Removable USB drive housing

30. Battery door

31. Rechargeable battery for the display.

### DETAILED DESCRIPTION OF DRAWINGS

FIG. 1 shows the display unit 1. The LCD display 2 shows both the advertisements and offers, but also works as the display for the user as he or she selects advertisements or offers, makes their own offers, and chooses timing and other selections from the portable transmitter/receiver selection options. The display unit has a cell phone antenna 3, and a cell phone module 4 that receives emergency or missing child alerts and then displays those alerts on the display, and also activates the LCD strobe lights 7. The display has an on/off switch 5, a battery 11, a power cord outlet 10 and a memory port 9 which the removable USB holder 23 can be inserted. The display also includes speakers 6 for missing children alerts, an ambient light sensor module 8 that both reads the ambient lighting but also adjust lighting levels of the display based on the ambient lighting. Not shown are the connection cord between the display and the portable transmitter/receiver and the power cord which has connections both for the car power source (at one time a holder for a cigarette lighter) and a standard wall outlet.

FIG. 2 demonstrates how in the preferred embodiment the display is positioned in the vehicle so that the user can obtain advertisements or offers, from the advertising server place their own ads, set up timing for the ads and perform other programing or selection functions required. The display 1 has its flexible mounting rods 12 wrapped around the headrest posts 15 and rests against the car seat 16.

FIG. 3 shows how the display is mounted to the car window in the preferred embodiment. The display 1 is attached to the window 18 by suction cups 17 are attached to the tops of the flexible mounding rods 12. Not shown, the back of the display has holders on either side to hold the excess length of the flexible mounting rods 12.

FIG. 4 shows the front side of the portable transmitter/receiver 19 components with the USB drive 23, and the USB memory module 28 held by the USB housing 29 inserted into the USB port 22. The portable transmitter/receiver unit has a cell phone antenna 20 to connect wirelessly to the advertising server. The cell phone module also receives the missing children and emergency alerts and then wirelessly communicates to the display screen when the memory housing 29 is plugged into the portable transmitter display device 19 at the USB port 22. The removable USB housing 29 is used to transfer information from the portable transmitter/receiver to the display by taking the portable USB holder 22 and inserting it into the memory device port of the display 9. The buttons on the front of the portable transmitter/receiver include an on/off switch 21, a select button 24, a next button 25 and a back button 26. Underneath the buttons is the portable transmitter/receiver processing module (with Bluetooth antenna) 27.

FIG. 5 shows the portable transmitter/receiver device 19, with the removable USB holder 28 removed. New features on this drawing include the rechargeable battery 31, and the battery door 30. Not show on FIG. 4 or 5 are the connection cord between the display and the portable transmitter/receiver and the power cord which has connections both for the car power source (at one time a holder for a cigarette lighter) and a standard wall outlet.

We claim:

1. A method for creating advertising revenue for vehicle users comprising:
a. A portable transmitter/receiver that is kept by vehicle users;
b. A display that can be attached inside or outside of a vehicle with flexible mounting rods;
c. The display has an ambient light sensor and light adjustment feature that allows the display brightness to vary based on ambient lighting;
d. An advertising server that stores advertisements or offers generated by efforts of a party running the advertising server;
e. A method for the advertising server to generate a separate code for each vehicle user;
f. A method to download advertisements or offers to the portable transmitters/receivers through the use of a computer and memory device that can connect to a memory port on the portable transmitter/receiver;
g. A method for the advertising server to code all coupons and offers received shown on the vehicle user's display with the vehicle user code number;
h. A method for the vehicle users to use the portable transmitter/receivers to select the actual advertisement(s) or offer(s) that will show on the vehicle users' displays;
i. The party running the advertising server arranging for an app (application) to be placed in the app (application) store of leading cell phone operating systems;
j. Responders desiring to respond to an advertisement and offer can do so by downloading the app (application) from the cell phone app store;
k. The advertising server sends out to the responders the appropriate coupon, offer, or other communication with the vehicle user code registered on the coupon or offer;
l. The advertising server calculates revenue for vehicle users and distributes revenue to the vehicle user on a prearranged basis.

2. The method of claim 1 where vehicle users can generate their own advertisements and offers and post them on the advertising server.

3. The method of claim 1 where the advertising server and/or creation software allows a vehicle user to have personal channel that stores advertisements and offers that only that vehicle user can access.

4. The method of claim 1 where emergency and missing child alerts are received by the wireless feature of the portable transmitter/receiver which will then show the alerts on the displays of the vehicle users.

5. The method of claim 1 where the display has wireless cell phone reception for emergency and missing child alerts.

6. The method of claim 1 where the display is mounted with other means than flexible mounting rods, including hooks, hook and loop connections, snaps, and magnets.

7. The method of claim 1 where the display is configured to mount on the inside or outside of a non-vehicle window.

8. The method of claim 1 where the display is configured to mount to the outside of a backpack.

9. The method of claim 1 where the display is waterproof.
